(19) United States
(12) Patent Application Publication
(10) Pub. No.: US 2026/0288140 A1
(43) Pub. Date: Sep. 24, 2026

(54) VEHICLE CONTROL SYSTEM

(71) Applicant: HONDA MOTOR CO., LTD., Tokyo (JP)

(72) Inventors: Shun MORISHITA, Tokyo (JP); Nobuharu NAGAOKA, Tokyo (JP); Hiromu AOKI, Tokyo (JP)

(21) Appl. No.: 19/545,621

(22) Filed: Feb. 20, 2026

(30) Foreign Application Priority Data
Mar. 20, 2025 (JP) 2025-046147

(51) Int. Cl. G05D 1/242; B60W 50/00; G06V 20/56

(52) U.S. Cl. CPC G05D 1/242; B60W 50/00; G06V 20/588; B60W 2050/0091; B60W 2420/403; B60W 2420/408; B60W 2552/30

(57) ABSTRACT

A vehicle control system includes a camera, an electromagnetic wave sensor, a surrounding recognizer configured to recognize a partition line based on a detection result of the camera and the electromagnetic wave sensor, and a driving controller configured to execute driving control of a vehicle based on a recognition result of the surrounding recognizer. A traveling path of the vehicle includes a straight section and a specific section. The surrounding recognizer is configured to execute a first recognition process as a recognition process of the partition line, prioritize the detection result of the camera over the detection result of the electromagnetic wave sensor in recognizing the partition line of the straight section in the first recognition process, and prioritize the detection result of the electromagnetic wave sensor over the detection result of the camera in recognizing the partition line of the specific section in the first recognition process.

### TECHNICAL FIELD

The present invention relates to a vehicle control system.

### BACKGROUND ART

In recent years, there has been an increase in efforts to provide sustainable transport systems that take into consideration vulnerable people among transport participants. To achieve this, research and development into a driving assistance technology is being conducted to further improve traffic safety and convenience.

For example, JP2010-69921A discloses a lane recognizing device used in a driving assistance device. This lane recognizing device includes a first imaging means (front camera) that captures an image in front of an own vehicle, a second imaging means (side camera and the like) that captures an image in a range different from the imaging range of the first imaging means, and a recognizing means that switches the captured image used to recognize a lane depending on the reliability of lane recognition.

The traveling path of a vehicle may include a section with a large degree of curvature or a large road surface gradient. In a case where a partition line (such as a lane marking) is present in such a section, the detection accuracy of a partition line detected by a camera may decrease, and there is room for improvement in the recognition accuracy of the partition line.

### SUMMARY OF THE INVENTION

In view of the above background, an object of the present invention is to provide a vehicle control system that can improve the recognition accuracy of a partition line present in a section with a large degree of curvature or a large road surface gradient. Further, another object of the present invention is to contribute to the development of sustainable transport systems.

To achieve such an object, one aspect of the present invention provides a vehicle control system comprising: a camera configured to capture a surrounding of a vehicle; an electromagnetic wave sensor configured to emit an electromagnetic wave toward the surrounding of the vehicle and receive a reflection wave of the electromagnetic wave; a surrounding recognizer configured to recognize a partition line in front of the vehicle in a traveling direction thereof based on a detection result of at least one of the camera or the electromagnetic wave sensor; and a driving controller configured to execute driving control of the vehicle based on a recognition result of the surrounding recognizer, wherein a traveling path of the vehicle includes: a straight section in which each of a degree of curvature and a road surface gradient is less than a threshold; and a specific section in which at least one of the degree of curvature or the road surface gradient is equal to or greater than the threshold, and the surrounding recognizer is configured to: execute a first recognition process as a recognition process of the partition line; prioritize the detection result of the camera over the detection result of the electromagnetic wave sensor in recognizing the partition line of the straight section in the first recognition process; and prioritize the detection result of the electromagnetic wave sensor over the detection result of the camera in recognizing the partition line of the specific section in the first recognition process.

Thus, according to the above aspects, it is possible to provide a vehicle control system that can improve the recognition accuracy of a partition line present in a section with a large degree of curvature or a large road surface gradient.

### BRIEF DESCRIPTION OF THE DRAWING(S)

FIG. 1 is a block diagram showing a vehicle to which a vehicle control system according to an embodiment is applied;

FIG. 2 is a table showing a partition line recognition process by a surrounding recognizer according to the embodiment;

FIG. 3 is a plan view showing a state where the vehicle according to the embodiment is traveling in a straight section;

FIG. 4 is a plan view showing a state where the vehicle according to the embodiment is traveling in a curve section;

FIG. 5 is a plan view showing a state where the vehicle according to the embodiment enters the straight section from the curve section;

FIG. 6 is a flowchart showing an example 1 of vehicle control according to the embodiment;

FIG. 7 is a flowchart showing an example 2 of the vehicle control according to the embodiment; and

FIG. 8 is a flowchart showing an example 3 of the vehicle control according to the embodiment.

### DETAILED DESCRIPTION OF THE INVENTION

In the following, an embodiment of a vehicle control system 1 will be described with reference to the drawings.

### the Vehicle 3

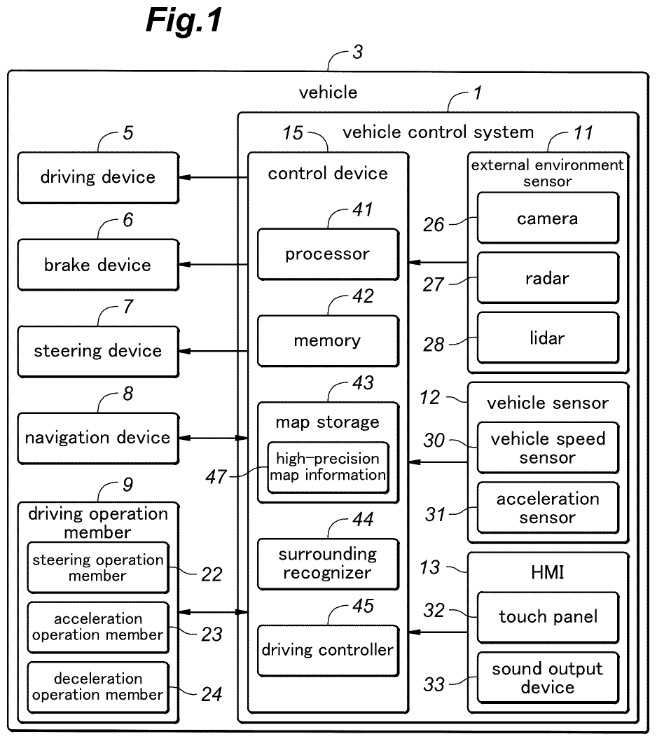

FIG. 1 is a block diagram showing a vehicle 3 to which the vehicle control system 1 is applied. For example, the vehicle 3 is an automobile. In another embodiment, the vehicle 3 may be a vehicle other than an automobile (for example, a motorcycle).

The vehicle 3 includes a driving device 5, a brake device 6, a steering device 7, a navigation device 8, a driving operation member 9, an external environment sensor 11, a vehicle sensor 12, an HMI 13 (Human Machine Interface), and a control device 15. In the present embodiment, the external environment sensor 11, the vehicle sensor 12, the HMI 13, and the control device 15 constitute the vehicle control system 1.

The driving device 5 is a device that applies a driving force to the vehicle 3. The driving device 5 includes a driving source that generates the driving force for causing the vehicle 3 to travel. For example, the driving source may be composed of an internal combustion engine and/or an electric motor.

The brake device 6 is a device that applies a braking force to the vehicle 3. For example, the brake device 6 includes a brake caliper that presses a pad against a brake rotor, and an electric cylinder that supplies hydraulic pressure to the brake caliper.

The steering device 7 is a device that changes the steering angle of wheels by turning the wheels. For example, the steering device 7 includes a rack and pinion mechanism connected to the wheels, and an electric motor that drives the rack and pinion mechanism.

The navigation device 8 is a device that provides route guidance to the destination of the vehicle 3. The navigation device 8 stores map information. The navigation device 8 determines the current position of the vehicle 3 based on GNSS signals (for example, GPS signals) received from artificial satellites.

The driving operation member 9 is a device that receives driving operations by an occupant of the vehicle 3 (hereinafter simply referred to as “the occupant”). The driving operation member 9 includes a steering operation member 22 (for example, a steering wheel) that receives a steering operation of the vehicle 3 by the occupant, an acceleration operation member 23 (for example, an accelerator pedal) that receives an acceleration operation of the vehicle 3 by the occupant, and a deceleration operation member 24 (for example, a brake pedal) that receives a deceleration operation of the vehicle 3 by the occupant.

The external environment sensor 11 is a device that acquires information about the surroundings of the vehicle 3. The external environment sensor 11 includes a plurality of cameras 26, a plurality of radars 27, and a plurality of lidars 28 (LiDAR). Each camera 26 captures images of objects (other vehicles, pedestrians, road structures, partition lines such as lane markings, and the like) present in the surroundings of the vehicle 3. Each radar 27 emits radio waves such as millimeter waves toward the surroundings of the vehicle 3 and receives the reflection waves of the radio waves to detect the positions of the objects present in the surroundings of the vehicle 3. Each lidar 28 is an example of an electromagnetic wave sensor. Each lidar 28 emits laser light (an example of an electromagnetic wave) such as infrared rays toward the surroundings of the vehicle 3 and receives the reflection waves of the laser light to detect the positions of the objects present in the surroundings of the vehicle 3.

The vehicle sensor 12 is a sensor that detects the traveling state of the vehicle 3. The vehicle sensor 12 includes a vehicle speed sensor 30 that detects the vehicle speed of the vehicle 3 and an acceleration sensor 31 that detects the acceleration and deceleration of the vehicle 3.

The HMI 13 is a device that executes a notification to the occupant and receives operations by the occupant. The HMI 13 includes a touch panel 32 and a sound output device 33. The touch panel 32 displays various screens to the occupant and also receives input operations by the occupant on the various screens. The sound output device 33 outputs audio guidance, warning sounds, and the like.

### the Control Device 15

The control device 15 is a computer including a processor 41 and a memory 42 communicatively connected to the processor 41. The processor 41 may include, for example, at least one of a CPU, a GPU, or an MPU as a core. The memory 42 stores programs executed by the processor 41 and various data. The memory 42 may include at least one of volatile memory or non-volatile memory. The volatile memory may be, for example, a DRAM or an SRAM. The non-volatile memory may be an SSD, a flash memory, a magnetic disk storage device, or an optical disk storage device. At least a portion of the control device 15 may be realized by hardware such as an LSI, an ASIC, or an FPGA, or may be realized by a combination of software and hardware. The control device 15 may be composed of a single piece of hardware, or may be composed of plural pieces of hardware that can communicate with each other.

The control device 15 includes a map storage 43, a surrounding recognizer 44, and a driving controller 45 as functional units. The processor 41 executes programs stored in the memory 42 to function as the map storage 43, the surrounding recognizer 44, and the driving controller 45.

The map storage 43 stores high-precision map information 47. The high-precision map information 47 is three-dimensional map information with higher precision than the map information stored in the navigation device 8. For example, the high-precision map information 47 includes information about partition lines X (for example, the positions, types, and the like of the partition lines X) on a traveling path T of the vehicle 3. For example, the partition lines X on the high-precision map are represented by nodes arranged at the prescribed intervals and links connecting the nodes. In another embodiment, the map storage 43 may store learning map information generated from the detection results of the onboard sensors of the vehicle 3 (i.e., the own vehicle) and/or other vehicles, and this learning map information may include information about the partition lines X.

The surrounding recognizer 44 recognizes the state of the surroundings of the vehicle 3 based on the detection result of the external environment sensor 11. For example, the surrounding recognizer 44 recognizes the partition lines X in front of the vehicle 3 in the traveling direction thereof based on the detection result of the camera 26 (i.e., the image captured by the camera 26) and the detection result of the lidar 28 (i.e., the positions of the objects detected by the lidar 28). Hereinafter, the partition lines X recognized by the surrounding recognizer 44 based on the detection result of the camera 26 will be referred to as “camera partition lines XC,” and the partition lines X recognized by the surrounding recognizer 44 based on the detection result of the lidar 28 will be referred to as “lidar partition lines XL.” The surrounding recognizer 44 recognizes the degree of curvature and the road surface gradient of the traveling path T of the vehicle 3 based on the detection result of the lidar 28.

The surrounding recognizer 44 recognizes the state of the surroundings of the vehicle 3 based on the map information (for example, the high-precision map information 47 or the learning map information) stored in the map storage 43 and the current position of the vehicle 3. Hereinafter, the partition lines X recognized by the surrounding recognizer 44 based on the map information (for example, the high-precision map information 47 or the learning map information) and the current position of the vehicle 3 will be referred to as “map partition lines XM.”

The driving controller 45 executes driving control of the vehicle 3 based on the recognition result of the surrounding recognizer 44. For example, the driving controller 45 executes lane keeping assistance control as the driving control of the vehicle 3. In the lane keeping assistance control, the driving controller 45 recognizes the lane based on the partition lines X, and controls the steering operation member 22 and the steering device 7 such that the vehicle 3 maintains a traveling position within the lane.

The driving control of the vehicle 3 executed by the driving controller 45 includes the first-level driving control and the second-level driving control. The second-level driving control provides a higher degree of driving assistance than the first-level driving control, or imposes fewer tasks on the occupant of the vehicle 3 than the first-level driving control. For example, the driving controller 45 executes, as the first-level driving control, the lane keeping assistance control in a hands-on mode (a mode requiring the driver to grip the steering operating member 22). For example, the driving controller 45 executes, as the second-level driving control, the lane keeping assistance control in the hands-off mode (a mode that allows the driver to release their hands from the steering operating member 22).

### the Partition Line Recognition Process by the Surrounding Recognizer 44

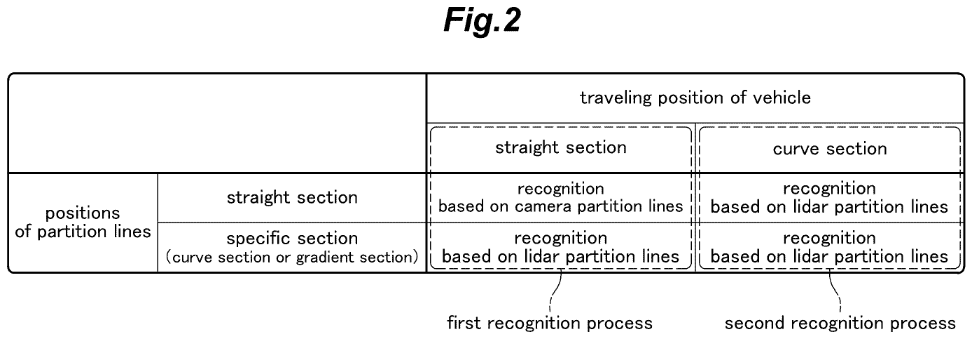

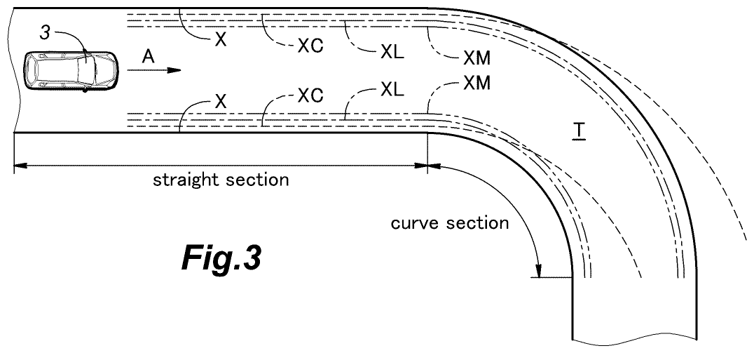

Next, the partition line recognition process by the surrounding recognizer 44 will be described with reference to FIGS. 2 to 5. A “straight section” in FIG. 2 indicates a section on the traveling path T of the vehicle 3 in which each of the degree of curvature and the road surface gradient is less than a threshold. A “specific section” in FIG. 2 indicates a section on the traveling path T of the vehicle 3 in which at least one of the degree of curvature or the road surface gradient is equal to or greater than the threshold. A “curve section” in FIG. 2 indicates a section of the specific section in which the degree of curvature is equal to or greater than the threshold. A “gradient section” in FIG. 2 indicates a section of the specific section in which the road surface gradient is equal to or greater than the threshold. Hereinafter, the partition lines X present in the straight section, the specific section, and the curve section will be referred to as the partition lines X of the straight section, the partition lines X of the specific section, and the partition lines X of the curve section, respectively. An arrow A shown in each of FIGS. 3 to 5 indicates the traveling direction of the vehicle 3.

With reference to FIGS. 2 and 3, when the vehicle 3 is traveling in the straight section, both the camera 26 and the lidar 28 can accurately detect the partition lines X of the straight section. The detection distance of the camera 26 is longer than the detection distance of the lidar 28. Further, the calculation processing amount of the camera 26 is less than the calculation processing amount of the lidar 28. Further, the camera 26 can detect the color of the partition lines X, but the lidar 28 cannot detect the color of the partition lines X. Accordingly, when the vehicle 3 is traveling in the straight section, the surrounding recognizer 44 recognizes the partition lines X of the straight section based on the camera partition lines XC.

When the vehicle 3 is traveling in the straight section, the camera 26 cannot accurately detect the partition lines X of the specific section. On the other hand, the lidar 28 can accurately detect the partition lines X of the specific section (because the lidar 28 detects the positions of the objects based on the reflection waves of the laser light). Accordingly, when the vehicle 3 is traveling in the straight section, the surrounding recognizer 44 recognizes the partition lines X of the specific section based on the lidar partition lines XL.

As described above, when the vehicle 3 is traveling in the straight section, the surrounding recognizer 44 prioritizes the detection result of the camera 26 over the detection result of the lidar 28 in recognizing the partition lines X of the straight section, and prioritizes the detection result of the lidar 28 over the detection result of the camera 26 in recognizing the partition lines X of the specific section. Hereinafter, such a recognition process of the partition lines X will be referred to as “the first recognition process.”

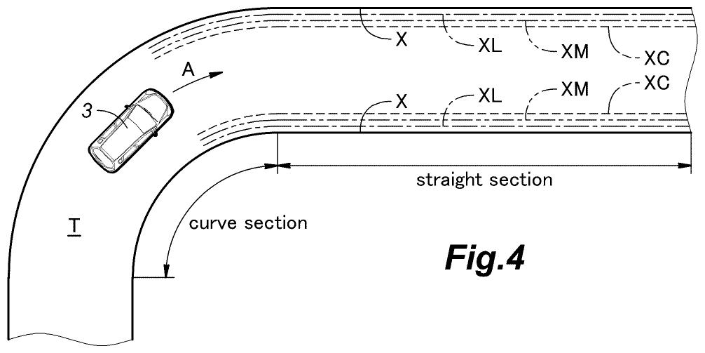

With reference to FIGS. 2 and 4, when the vehicle 3 is traveling in the curve section, the roll of the vehicle 3 causes the vehicle 3 to tilt, and therefore the camera 26 cannot accurately detect the partition lines X of the straight section and the specific section. Further, a process for correcting the tilt of the camera 26 may be required. On the other hand, the lidar 28 can accurately detect the partition lines X of the straight section and the specific section (because the lidar 28 detects the positions of the objects based on the reflection waves of the laser light). Accordingly, when the vehicle 3 is traveling in the curve section, the surrounding recognizer 44 recognizes the partition lines X of the straight section and the specific section based on the lidar partition lines XL.

As described above, when the vehicle 3 is traveling in the curve section, the surrounding recognizer 44 prioritizes the detection result of the lidar 28 over the detection result of the camera 26 in recognizing the partition lines X of the straight section and the specific section. Hereinafter, such a recognition process of the partition lines X will be referred to as “the second recognition process.”

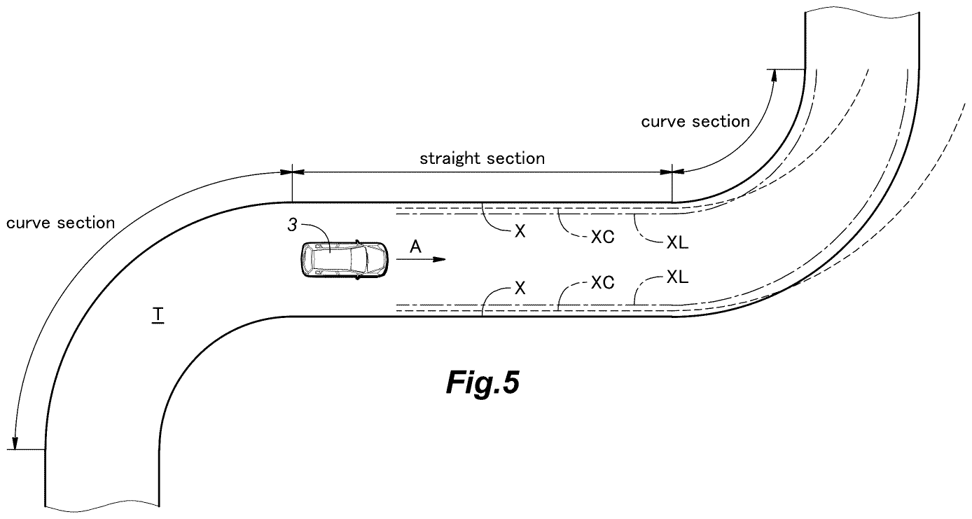

With reference to FIG. 5, there is a case where the vehicle 3 passes through the curve section and enters the straight section. In such a case, the surrounding recognizer 44 changes the recognition process of the partition lines X from the second recognition process to the first recognition process after the vehicle 3 passes through the curve section and enters the straight section. However, according to another embodiment, the surrounding recognizer 44 may change the recognition process of the partition lines X from the second recognition process to the first recognition process before the vehicle 3 passes through the curve section and enters the straight section.

Although not shown in the drawings, there is a case where the vehicle 3 passes through the straight section and enters the curve section. In such a case, the surrounding recognizer 44 changes the recognition process of the partition lines X from the first recognition process to the second recognition process before the vehicle 3 passes through the straight section and enters the curve section. However, according to another embodiment, the surrounding recognizer 44 may change the recognition process of the partition lines X from the first recognition process to the second recognition process after the vehicle 3 passes through the straight section and enters the curve section.

### the Partition Line Correction Process

Next, with reference to FIG. 3, the partition line correction process by the surrounding recognizer 44 will be described. The partition line correction process is a process that corrects the lidar partition lines XL based on the camera partition lines XC for the straight section. In other words, the partition line correction process is a process that corrects the detection result of the lidar 28 based on the detection result of the camera 26 for the partition lines X of the straight section.

There may be a case where the vehicle 3 is traveling in the straight section and the specific section (the curve section in FIG. 3) is present in front of the vehicle 3 in the traveling direction thereof. In such a case, the surrounding recognizer 44 executes the partition line correction process before the vehicle 3 enters the specific section from the straight section (i.e., before changing the recognition process of the partition lines X from the first recognition process to the second recognition process).

In the partition line correction process, the surrounding recognizer 44 corrects the lidar partition lines XL based on the camera partition lines XC for the straight section. For example, in a case where there is a discrepancy between the angle of the camera partition lines XC and the angle of the lidar partition lines XL, the surrounding recognizer 44 corrects the lidar partition lines XL by rotating the lidar partition lines XL toward the camera partition lines XC. Further, in a case where there is a discrepancy between the lateral position of the camera partition lines XC and the lateral position of the lidar partition lines XL, the surrounding recognizer 44 corrects the lidar partition lines XL by parallel transition of the lidar partition lines XL toward the camera partition lines XC. In the partition line correction process according to another embodiment, the surrounding recognizer 44 may correct the camera partition lines XC based on the lidar partition lines XL for the straight section.

### the Partition Line Lost Process

Next, the partition line lost process executed by the surrounding recognizer 44 will be described with reference to FIGS. 3 and 4. The partition line lost process is a process in a case where the partition lines X cannot be recognized based on the camera partition lines XC or the lidar partition lines XL (in a case where the partition lines X based on the camera partition lines XC or the lidar partition lines XL are lost).

With reference to FIG. 3, in a case where the surrounding recognizer 44 cannot recognize the partition lines X of the straight section based on the camera partition lines XC when the vehicle 3 is traveling in the straight section, the surrounding recognizer 44 recognizes the partition lines X of the straight section based on the lidar partition lines XL. In other words, in a case where the surrounding recognizer 44 cannot recognize the partition lines X of the straight section based on the detection result of the camera 26 when the vehicle 3 is traveling in the straight section, the surrounding recognizer 44 recognizes the partition lines X of the straight section based on the detection result of the lidar 28.

In a case where the surrounding recognizer 44 cannot recognize the partition lines X of the specific section based on the lidar partition lines XL when the vehicle 3 is traveling in the straight section, the surrounding recognizer 44 recognizes the partition lines X of the specific section based on the map partition lines XM. In other words, in a case where the surrounding recognizer 44 cannot recognize the partition lines X of the specific section based on the detection result of the lidar 28 when the vehicle 3 is traveling in the straight section, the surrounding recognizer 44 recognizes the partition lines X of the specific section based on the map information (for example, the high-precision map information 47 or the learning map information).

With reference to FIG. 4, in a case where the surrounding recognizer 44 cannot recognize the partition lines X of at least one of the straight section or the specific section based on the lidar partition lines XL when the vehicle 3 is traveling in the curve section, the surrounding recognizer 44 recognizes the partition lines X of the at least one of the straight section or the specific section based on the map partition lines XM. In other words, in a case where the surrounding recognizer 44 cannot recognize the partition lines X of at least one of the straight section or the specific section based on the detection result of the lidar 28 when the vehicle 3 is traveling in the curve section, the surrounding recognizer 44 recognizes the partition lines X of the at least one of the straight section or the specific section based on the map information (for example, the high-precision map information 47 or the learning map information).

### the Level Change Process by the Driving Controller 45

Next, the level change process by the driving controller 45 will be described with reference to FIGS. 3 and 4. The level change process is a process for changing the level of the driving control.

With reference to FIG. 3, when the vehicle 3 is traveling in the straight section with the second-level driving control, the surrounding recognizer 44 determines whether a first divergence between at least one of the camera partition lines XC or the lidar partition lines XL and the map partition lines XM for the straight section is equal to or less than a prescribed value. In a case where the surrounding recognizer 44 determines that the first divergence between the at least one of the camera partition lines XC or the lidar partition lines XL and the map partition lines XM is equal to or less than the prescribed value, the driving controller 45 continues the second-level driving control. On the other hand, in a case where the surrounding recognizer 44 determines that the first divergence between both the camera partition lines XC and the lidar partition lines XL and the map partition lines XM is greater than the prescribed value, the driving controller 45 stops the second-level driving control and starts the first-level driving control. That is, the driving controller 45 lowers the level of the driving control from the second level to the first level.

When the vehicle 3 is traveling in the straight section with the second-level driving control, the surrounding recognizer 44 determines whether a second divergence between the lidar partition lines XL and the map partition lines XM for the specific section is equal to or less than a prescribed value. In a case where the surrounding recognizer 44 determines that the second divergence between the lidar partition lines XL and the map partition lines XM is equal to or less than the prescribed value, the driving controller 45 continues the second-level driving control. On the other hand, in a case where the surrounding recognizer 44 determines that the second divergence between the lidar partition lines XL and the map partition lines XM is greater than the prescribed value, the driving controller 45 stops the second-level driving control and starts the first-level driving control. That is, the driving controller 45 lowers the level of the driving control from the second level to the first level.

With reference to FIG. 4, when the vehicle 3 is traveling in the curve section with the second-level driving control, the surrounding recognizer 44 determines whether a third divergence between the lidar partition lines XL and the map partition lines XM is equal to or less than a prescribed value for the straight section and the specific section. In a case where the surrounding recognizer 44 determines that the third divergence between the lidar partition lines XL and the map partition lines XM is equal to or less than the prescribed value, the driving controller 45 continues the second-level driving control. On the other hand, in a case where the surrounding recognizer 44 determines that the third divergence between the lidar partition lines XL and the map partition lines XM is greater than the prescribed value, the driving controller 45 stops the second-level driving control and starts the first-level driving control. That is, the driving controller 45 lowers the level of the driving control from the second level to the first level.

### the Example 1 of the Vehicle Control

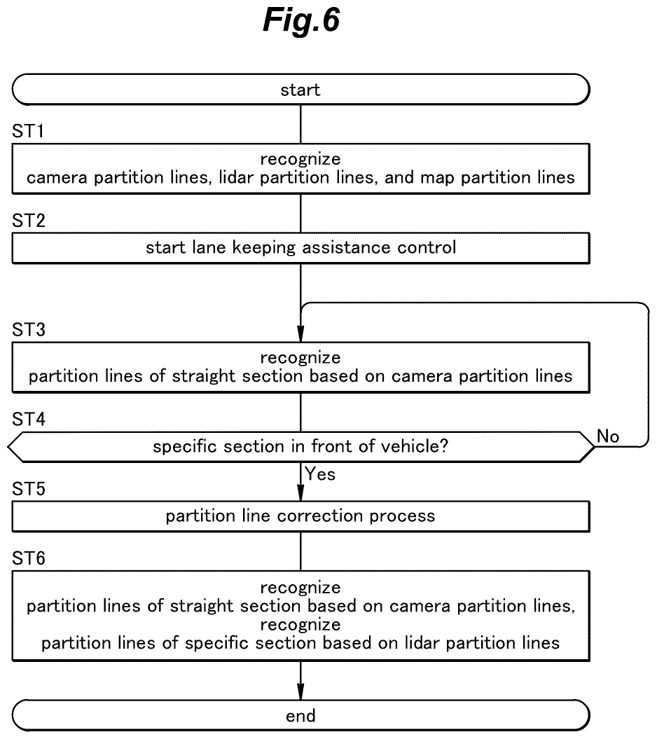

Next, with reference to FIG. 6, an example 1 of the vehicle control including the driving control will be described. The example 1 of the vehicle control is an example of the vehicle control in a case where the vehicle 3 is traveling in the straight section.

When the main power supply of the vehicle 3 is turned on, the surrounding recognizer 44 recognizes the camera partition lines XC, the lidar partition lines XL, and the map partition lines XM (step ST1). Next, the driving controller 45 starts the lane keeping assistance control according to an operation on the HMI 13 by the driver (step ST2).

When the lane keeping assistance control is started, the surrounding recognizer 44 recognizes the partition lines X of the straight section based on the camera partition lines XC (step ST3). The driving controller 45 generates the trajectory of the vehicle 3 for the lane keeping assistance control based on the partition lines X of the straight section recognized by the surrounding recognizer 44, and causes the vehicle 3 to travel along the generated trajectory.

While the vehicle 3 is traveling in the straight section, the surrounding recognizer 44 determines whether the specific section is present in front of the vehicle 3 in the traveling direction thereof (step ST4). In a case where the specific section is not present in front of the vehicle 3 in the traveling direction thereof (step ST4: No), the surrounding recognizer 44 repeats the determination in step ST4 while recognizing the partition lines X of the straight section based on the camera partition lines XC (step ST3).

In a case where the specific section is present in front of the vehicle 3 in the traveling direction thereof (step ST4: Yes), the surrounding recognizer 44 executes the above-mentioned partition line correction process (step ST5). That is, the surrounding recognizer 44 corrects the lidar partition lines XL based on the camera partition lines XC for the straight section.

Next, the surrounding recognizer 44 recognizes the partition lines X of the straight section based on the camera partition lines XC, and recognizes the partition lines X of the specific section based on the lidar partition lines XL (step ST6). The driving controller 45 generates the trajectory of the vehicle 3 for the lane keeping assistance control based on the partition lines X of the straight section and the specific section recognized by the surrounding recognizer 44, and causes the vehicle 3 to travel along the generated trajectory.

### the Example 2 of the Vehicle Control

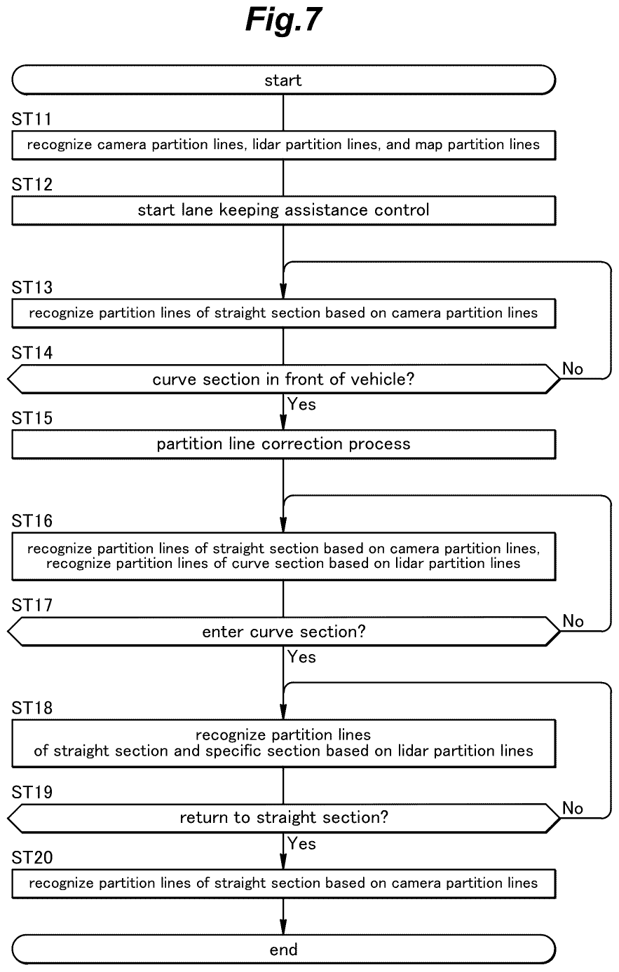

Next, with reference to FIG. 7, an example 2 of the vehicle control including the driving control will be described. The example 2 of the vehicle control is an example of the vehicle control in a case where the vehicle 3 enters the curve section from the straight section and then returns to the straight section from the curve section. Steps ST11-ST13 of the example 2 of the vehicle control are similar to steps ST1-ST3 of the example 1 of the vehicle control, and therefore the description thereof will be omitted.

After step ST13 is completed, while the vehicle 3 is traveling in the straight section, the surrounding recognizer 44 determines whether the curve section is present in front of the vehicle 3 in the traveling direction thereof (step ST14). In a case where the curve section is not present in front of the vehicle 3 in the traveling direction thereof (step ST14: No), the surrounding recognizer 44 repeats the determination in step ST14 while recognizing the partition lines X of the straight section based on the camera partition lines XC (step ST13).

In a case where the curve section is present in front of the vehicle 3 in the traveling direction thereof (step ST14: Yes), the surrounding recognizer 44 executes the above-mentioned partition line correction process (step ST15). That is, the surrounding recognizer 44 corrects the lidar partition lines XL based on the camera partition lines XC for the straight section.

Next, the surrounding recognizer 44 recognizes the partition lines X of the straight section based on the camera partition lines XC, and recognizes the partition lines X of the curve section based on the lidar partition lines XL (step ST16). The driving controller 45 generates the trajectory of the vehicle 3 for the lane keeping assistance control based on the partition lines X of the straight section and the curve section recognized by the surrounding recognizer 44, and causes the vehicle 3 to travel along the generated trajectory.

Next, the surrounding recognizer 44 determines whether the vehicle 3 has entered the curve section (step ST17). In a case where the vehicle 3 has not entered the curve section (step ST17: No), the surrounding recognizer 44 repeats the determination in step ST17 while recognizing the partition lines X of the straight section based on the camera partition lines XC and recognizing the partition lines X of the curve section based on the lidar partition lines XL (step ST16).

In a case where the vehicle 3 has entered the curve section (step ST17: Yes), the surrounding recognizer 44 recognizes the partition lines X of the straight section and the specific section (for example, the curve section or the gradient section) based on the lidar partition lines XL (step ST18). The driving controller 45 generates the trajectory of the vehicle 3 for the lane keeping assistance control based on the partition lines X of the straight section and the specific section recognized by the surrounding recognizer 44, and causes the vehicle 3 to travel along the generated trajectory.

Next, the surrounding recognizer 44 determines whether the vehicle 3 has returned to the straight section (step ST19). In a case where the vehicle 3 has not returned to the straight section (step ST19: No), the surrounding recognizer 44 repeats the determination in step ST19 while recognizing the partition lines X of the straight section and the specific section based on the lidar partition lines XL (step ST18).

In a case where the vehicle 3 has returned to the straight section (step ST19: Yes), the surrounding recognizer 44 recognizes the partition lines X of the straight section based on the camera partition lines XC (step ST20). The driving controller 45 generates the trajectory of the vehicle 3 for the lane keeping assistance control based on the partition lines X of the straight section recognized by the surrounding recognizer 44, and causes the vehicle 3 to travel along the generated trajectory.

### the Example 3 of the Vehicle Control

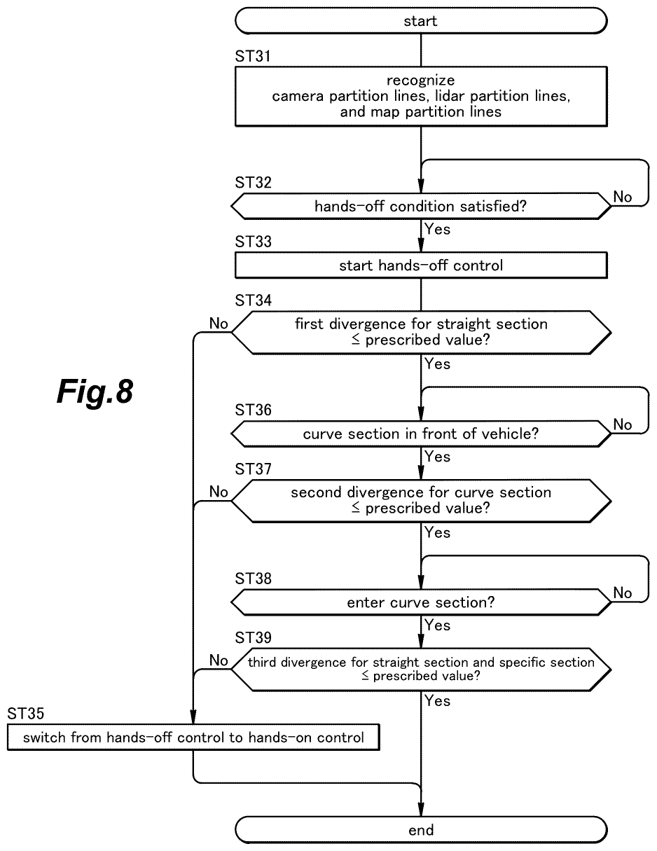

Next, with reference to FIG. 8, an example 3 of the vehicle control including the driving control will be described. The example 3 of the vehicle control is an example of the vehicle control in a case where the vehicle 3 enters the curve section from the straight section and then returns to the straight section from the curve section. Step ST31 of the example 3 of the vehicle control is similar to step ST1 of the example 1 of the vehicle control, and therefore the description thereof will be omitted. Hereinafter, the lane keeping assistance control in the hands-on mode will be abbreviated as “the hands-on control,” and the lane keeping assistance control in the hands-off mode will be abbreviated as “the hands-off control.”

When step ST31 is completed, the surrounding recognizer 44 determines whether a hands-off condition is satisfied (step ST32). The hands-off condition is a condition for determining whether the hands-off control is executable. For example, in a case where the camera partition lines XC or the lidar partition lines XL match the map partition lines XM, the surrounding recognizer 44 determines that the hands-off condition is satisfied. On the other hand, in a case where the camera partition lines XC and the lidar partition lines XL do not match the map partition lines XM, the surrounding recognizer 44 determines that the hands-off condition is not satisfied. In another embodiment, the hands-off condition may include a condition related to the traveling state of the vehicle 3, the driving state of the driver, and the like, in addition to or instead of the above-mentioned condition related to the matching of the partition lines. In a case where the hands-off condition is not satisfied (step ST32: No), the surrounding recognizer 44 repeats the determination in step ST32 until the hands-off condition is satisfied.

In a case where the hands-off condition is satisfied (step ST32: Yes), the driving controller 45 starts the hands-off control (step ST33). That is, the driving controller 45 starts the second-level driving control.

When the driving controller 45 starts the hands-off control, the surrounding recognizer 44 determines whether the first divergence between the camera partition lines XC or the lidar partition lines XL and the map partition lines XM for the straight section is equal to or less than the prescribed value (step ST34). In a case where the first divergence between both the camera partition lines XC and the lidar partition lines XL and the map partition lines XM for the straight section is greater than the prescribed value (step ST34: No), the driving controller 45 switches the driving control from the hands-off control to the hands-on control (step ST35). That is, the driving controller 45 lowers the level of the driving control from the second level to the first level.

In a case where the first divergence between the camera partition lines XC or the lidar partition lines XL and the map partition lines XM for the straight section is equal to or less than the prescribed value (step ST34: Yes), the driving controller 45 continues the hands-off control. In this case, the surrounding recognizer 44 determines whether the curve section is present in front of the vehicle 3 in the traveling direction thereof (step ST36). In a case where the curve section is not present in front of the vehicle 3 in the traveling direction thereof (step ST36: No), the surrounding recognizer 44 repeats the determination in step ST36.

In a case where the curve section is present in front of the vehicle 3 in the traveling direction thereof (step ST36: Yes), the surrounding recognizer 44 determines whether the second divergence between the lidar partition lines XL and the map partition lines XM for the curve section is equal to or less than the prescribed value (step ST37). In a case where the second divergence between the lidar partition lines XL and the map partition lines XM for the curve section is greater than the prescribed value (step ST37: No), the driving controller 45 switches the driving control from the hands-off control to the hands-on control (step ST35). That is, the driving controller 45 lowers the level of the driving control from the second level to the first level.

In a case where the second divergence between the lidar partition lines XL and the map partition lines XM for the curve section is equal to or less than the prescribed value (step ST37: Yes), the driving controller 45 continues the hands-off control. In this case, the surrounding recognizer 44 determines whether the vehicle 3 has entered the curve section (step ST38). In a case where the vehicle 3 has not entered the curve section (step ST38: No), the surrounding recognizer 44 repeats the determination in step ST38.

In a case where the vehicle 3 has entered the curve section (step ST38: Yes), the surrounding recognizer 44 determines whether the third divergence between the lidar partition lines XL and the map partition lines XM for the straight section and the specific section (for example, the curve section or the gradient section) is equal to or less than the prescribed value (step ST39). In a case where the third divergence between the lidar partition lines XL and the map partition lines XM for the straight section or the specific section is greater than the prescribed value (step ST39: No), the driving controller 45 switches the driving control from the hands-off control to the hands-on control. That is, the driving controller 45 lowers the level of the driving control from the second level to the first level. In a case where the third divergence between the lidar partition lines XL and the map partition lines XM for the straight section and the specific section is equal to or less than the prescribed value (step ST39: Yes), the driving controller 45 continues the hands-off control.

### Effects

In a case where the vehicle 3 is traveling in the straight section and the partition lines X are present in the specific section (the curve section or the gradient section), the detection accuracy of the camera partition lines XC decreases. Accordingly, if an attempt is made to recognize the partition lines X based only on the camera partition lines XC, the recognition accuracy of the partition lines X may decrease. If the driving control (for example, the lane keeping assistance control) is executed in a state where the recognition accuracy of the partition lines X decreases in this way, the driver may feel discomfort. Considering this, the surrounding recognizer 44 recognizes the partition lines X of the specific section based on the lidar partition lines XL in the first recognition process (the recognition process when the vehicle 3 is traveling in the straight section). This improves the recognition accuracy of the partition lines X in the specific section, thereby reducing the discomfort felt by the driver when the driving control is executed.

On the other hand, in a case where the vehicle 3 is traveling in the straight section and the partition lines X are present in the straight section, the detection accuracy of the camera partition lines XC and the lidar partition lines XL is high. As described above, the camera 26 is superior to the lidar 28 in the detection distance, the calculation processing amount, the color detection, and the like. Considering this, in the first recognition process, the surrounding recognizer 44 recognizes the partition lines X of the straight section based on the camera partition lines XC. This improves the recognition accuracy of the partition lines X in the straight section, thereby further reducing the discomfort felt by the driver when the driving control is executed.

When the vehicle 3 is traveling in the curve section, the camera partition lines XC may deviate as the vehicle 3 rolls. Accordingly, if an attempt is made to recognize the partition lines X based only on the camera partition lines XC, the recognition accuracy of the partition lines X may decrease. Accordingly, in the second recognition process (the recognition process when the vehicle 3 is traveling in the curve section), the surrounding recognizer 44 recognizes the partition lines X of the straight section and the specific section based on the lidar partition lines XL. This improves the recognition accuracy of the partition lines X in the straight section and the specific section, thereby further reducing the discomfort felt by the driver when the driving control is executed.

### Other Modified Embodiments

In the above embodiment, in the first recognition process, the surrounding recognizer 44 recognizes the partition lines X of the straight section based on the camera partition lines XC. In another modified embodiment, in the first recognition process, the surrounding recognizer 44 may set the weighting ratio (for example, 90%) of the camera partition lines XC higher than the weighting ratio (for example, 10%) of the lidar partition lines XL in recognizing the partition lines X of the straight section. In other words, in the first recognition process, “prioritizing the detection result of the camera 26 over the detection result of the lidar 28 in recognizing the partition lines X of the straight section” encompasses “setting the weighting ratio of the camera partition lines XC higher than the weighting ratio of the lidar partition lines XL in recognizing the partition lines X of the straight section”. Similarly, in the first recognition process or the second recognition process, “prioritizing the detection result of the lidar 28 over the detection result of the camera 26 in recognizing the partition lines X of the straight section (or the specific section)” encompasses “setting the weighting ratio of the lidar partition lines XL higher than the weighting ratio of the camera partition lines XC in recognizing the partition lines X of the straight section (or the specific section)”.

In another modified embodiment, in the first recognition process, in a case where the surrounding recognizer 44 cannot recognize the partition lines X of the straight section based on the camera partition lines XC, the surrounding recognizer 44 may recognize the partition lines X of the straight section based on the lidar partition lines XL. In other words, in the first recognition process, “prioritizing the detection result of the camera 26 over the detection result of the lidar 28 in recognizing the partition lines X of the straight section” encompasses “using the lidar partition lines XL instead of the camera partition lines XC in a case where the partition lines X of the straight section are lost”. Similarly, in the first recognition process or the second recognition process, “prioritizing the detection result of the lidar 28 over the detection result of the camera 26 in recognizing the partition lines X of the straight section (or the specific section)” encompasses “using the camera partition lines XC instead of the lidar partition lines XL in a case where the partition lines X of the straight section (or the specific section) is lost”.

In another modified embodiment, in the first recognition process, the surrounding recognizer 44 may compare the camera partition lines XC (rather than the lidar partition lines XL) with the map partition lines XM for the partition lines X of the straight section. In other words, in the first recognition process, “prioritizing the detection result of the camera 26 over the detection result of the lidar 28 in recognizing the partition lines X of the straight section” encompasses “comparing the camera partition lines XC (rather than the lidar partition lines XL) with the map partition lines XM for the partition lines X of the straight section.” Similarly, in the first recognition process or the second recognition process, “prioritizing the detection result of the lidar 28 over the detection result of the camera 26 in recognizing the partition lines X of the straight section (or the specific section)” encompasses “comparing the lidar partition lines XL (rather than the camera partition lines XC) with the map partition lines XM for the partition lines X of the straight section (or the specific section)”.

In the above embodiment, the lidar 28 is an example of the electromagnetic wave sensor. In another embodiment, a sensor other than the lidar 28 (for example, the radar 27) may be an example of the electromagnetic wave sensor.

### Summary of Embodiments

According to one aspect, a vehicle control system 1 comprises: a camera 26 configured to capture a surrounding of a vehicle 3; an electromagnetic wave sensor 28 configured to emit an electromagnetic wave toward the surrounding of the vehicle 3 and receive a reflection wave of the electromagnetic wave; a surrounding recognizer 44 configured to recognize a partition line X in front of the vehicle 3 in a traveling direction thereof based on a detection result of at least one of the camera 26 or the electromagnetic wave sensor 28; and a driving controller 45 configured to execute driving control of the vehicle 3 based on a recognition result of the surrounding recognizer 44, wherein a traveling path T of the vehicle 3 includes: a straight section in which each of a degree of curvature and a road surface gradient is less than a threshold; and a specific section in which at least one of the degree of curvature or the road surface gradient is equal to or greater than the threshold, and the surrounding recognizer 44 is configured to: execute a first recognition process as a recognition process of the partition line X; prioritize a detection result of the camera 26 over a detection result of the electromagnetic wave sensor 28 in recognizing the partition line X of the straight section in the first recognition process; and prioritize the detection result of the electromagnetic wave sensor 28 over the detection result of the camera 26 in recognizing the partition line X of the specific section in the first recognition process.

According to this aspect, the surrounding recognizer 44 prioritizes the detection result of the electromagnetic wave sensor 28 over the detection result of the camera 26 in recognizing the partition line X of the specific section. This improves the recognition accuracy of the partition line X in the specific section, thereby reducing the discomfort felt by the driver when the driving control is executed. Further, it is possible to prevent the occurrence of a situation where the driving control cannot be continued due to the decrease in the recognition accuracy of the partition line X of the specific section, thereby improving the continuity of the driving control.

Preferably, the surrounding recognizer 44 is configured to execute the first recognition process when the vehicle 3 is traveling in the straight section.

According to this aspect, when the vehicle 3 is traveling in the straight section, the surrounding recognizer 44 prioritizes the detection result of the camera 26 over the detection result of the electromagnetic wave sensor 28 in recognizing the partition line X of the straight section. Accordingly, it is possible to utilize the advantages of the camera 26 to improve the recognition accuracy of the partition line X in the straight section, thereby further reducing the discomfort felt by the driver when the driving control is executed.

Preferably, the specific section includes a curve section in which the degree of curvature is equal to or greater than the threshold, and the surrounding recognizer 44 is configured to: execute a second recognition process as the recognition process of the partition line X when the vehicle 3 is traveling in the curve section; and prioritize the detection result of the electromagnetic wave sensor 28 over the detection result of the camera 26 in recognizing the partition line X of each of the straight section and the specific section in the second recognition process.

According to this aspect, when the vehicle 3 is traveling in the curve section, the surrounding recognizer 44 prioritizes the detection result of the electromagnetic wave sensor 28 over the detection result of the camera 26 in recognizing the partition line X of the straight section and the specific section. This improves the recognition accuracy of the partition line X in the straight section and the specific section, thereby further reducing the discomfort felt by the driver when the driving control is executed.

Preferably, the surrounding recognizer 44 is configured to change the recognition process of the partition line X from the second recognition process to the first recognition process after the vehicle 3 passes through the curve section and enters the straight section.

According to this aspect, in a case where the vehicle 3 passes through the curve section, it is possible to switch back the recognition process of the partition line X from the second recognition process to the first recognition process at proper timing, thereby further improving the recognition accuracy of the partition line X and the continuity of the driving control.

Preferably, the surrounding recognizer 44 is configured to recognize the partition line X based on map information 47, and the driving controller 45 is configured to: execute first-level driving control and second-level driving control, the second-level driving control providing a higher degree of driving assistance than the first-level driving control or imposing fewer tasks on an occupant of the vehicle 3 than the first-level driving control; and continue the second-level driving control in a case where a first divergence for the straight section is equal to or less than a prescribed value when the vehicle 3 is traveling in the straight section with the second-level driving control, the first divergence being a divergence between the partition line X recognized based on the detection result of the camera 26 or the electromagnetic wave sensor 28 and the partition line X recognized based on the map information 47.

According to this aspect, when the vehicle 3 is traveling in the straight section, it is possible to properly determine whether to continue the second-level driving control.

Preferably, the surrounding recognizer 44 is configured to recognize the partition line X based on map information 47, and the driving controller 45 is configured to: execute first-level driving control and second-level driving control, the second-level driving control providing a higher degree of driving assistance than the first-level driving control or imposing fewer tasks on an occupant of the vehicle 3 than the first-level driving control; and continue the second-level driving control in a case where a second divergence for the specific section is equal to or less than a prescribed value when the vehicle 3 is traveling in the straight section with the second-level driving control, the second divergence being a divergence between the partition line X recognized based on the detection result of the electromagnetic wave sensor 28 and the partition line X recognized based on the map information 47.

According to this aspect, when the vehicle 3 is traveling in the straight section, it is possible to properly determine whether to continue the second-level driving control.

Preferably, the specific section includes a curve section in which the degree of curvature is equal to or greater than the threshold, the surrounding recognizer 44 is configured to recognize the partition line X based on map information 47, and the driving controller 45 is configured to: execute first-level driving control and second-level driving control, the second-level driving control providing a higher degree of driving assistance than the first-level driving control or imposing fewer tasks on an occupant of the vehicle 3 than the first-level driving control; and continue the second-level driving control in a case where a third divergence for the straight section and the specific section is equal to or less than a prescribed value when the vehicle 3 is traveling in the curve section with the second-level driving control, the third divergence being a divergence between the partition line X recognized based on the detection result of the electromagnetic wave sensor 28 and the partition line X recognized based on the map information 47.

According to this aspect, when the vehicle 3 is traveling in the curve section, it is possible to properly determine whether to continue the second-level driving control.

Preferably, the surrounding recognizer 44 is configured to execute a partition line correction process in a case where the vehicle 3 is traveling in the straight section, the partition line correction process being a process that corrects the detection result of the electromagnetic wave sensor 28 based on the detection result of the camera 26 for the partition line X of the straight section.

When the vehicle 3 is traveling in the straight section, both the camera 26 and the electromagnetic wave sensor 28 can accurately detect the partition line X of the straight section. According to the above aspect, by matching one partition line X detected with high accuracy with another partition line X detected with high accuracy, it is possible to reduce the influence of the measurement error of the camera 26 and the electromagnetic wave sensor 28.

Preferably, the surrounding recognizer 44 is configured to execute the partition line correction process in a case where the vehicle 3 is traveling in the straight section and the specific section is present in front of the vehicle 3 in the traveling direction thereof.

According to this aspect, before the vehicle 3 enters the specific section from the straight section and the recognition process of the partition line X is switched, the partition line correction process can reduce the influence of the measurement error of the camera 26 and the electromagnetic wave sensor 28. This allows the recognition process of the partition line X to be switched smoothly.

Preferably, the surrounding recognizer 44 is configured to recognize the partition line X of the straight section based on the detection result of the electromagnetic wave sensor 28 in a case where the surrounding recognizer 44 cannot recognize the partition line X of the straight section based on the detection result of the camera 26 when the vehicle 3 is traveling in the straight section.

According to this aspect, even in a case where the partition line X of the straight section cannot be recognized based on the detection result of the camera 26 when the vehicle 3 is traveling in the straight section, the partition line X of the straight section can be recognized.

Preferably, the surrounding recognizer 44 is configured to: recognize the partition line X based on map information 47; and recognize the partition line X of the specific section based on the map information 47 in a case where the surrounding recognizer 44 cannot recognize the partition line X of the specific section based on the detection result of the electromagnetic wave sensor 28 when the vehicle 3 is traveling in the straight section.

According to this aspect, even in a case where the partition line X of the specific section cannot be recognized based on the detection result of the electromagnetic wave sensor 28 when the vehicle 3 is traveling in the straight section, the partition line X of the specific section can be recognized.

Preferably, the specific section includes a curve section in which the degree of curvature is equal to or greater than the threshold, and the surrounding recognizer 44 is configured to: recognize the partition line X based on map information 47; and recognize the partition line X of at least one of the straight section or the specific section based on the map information 47 in a case where the surrounding recognizer 44 cannot recognize the partition line X of the at least one of the straight section or the specific section based on the detection result of the electromagnetic wave sensor 28 when the vehicle 3 is traveling in the curve section.

According to this aspect, even in a case where the partition line X of the straight section or the specific section cannot be recognized based on the detection result of the electromagnetic wave sensor 28 when the vehicle 3 is traveling in the curve section (the specific section), the partition line X of the straight section or the specific section can be recognized.

Preferably, the electromagnetic wave sensor 28 is a lidar 28 configured to emit laser light toward the surrounding of the vehicle 3 and receive a reflection wave of the laser light, and the surrounding recognizer 44 is configured to recognize the degree of curvature and the road surface gradient of the traveling path T of the vehicle 3 based on a detection result of the lidar 28.

According to this aspect, using the lidar 28, it is possible to properly detect a state where the detection accuracy of the camera 26 is likely to decrease.

1. A vehicle control system, comprising:
a camera configured to capture a surrounding of a vehicle;
an electromagnetic wave sensor configured to emit an electromagnetic wave toward the surrounding of the vehicle and receive a reflection wave of the electromagnetic wave;
a surrounding recognizer configured to recognize a partition line in front of the vehicle in a traveling direction thereof based on a detection result of at least one of the camera or the electromagnetic wave sensor; and
a driving controller configured to execute driving control of the vehicle based on a recognition result of the surrounding recognizer,
wherein a traveling path of the vehicle includes:
a straight section in which each of a degree of curvature and a road surface gradient is less than a threshold; and
a specific section in which at least one of the degree of curvature or the road surface gradient is equal to or greater than the threshold, and
the surrounding recognizer is configured to:
execute a first recognition process as a recognition process of the partition line;
prioritize the detection result of the camera over the detection result of the electromagnetic wave sensor in recognizing the partition line of the straight section in the first recognition process; and
prioritize the detection result of the electromagnetic wave sensor over the detection result of the camera in recognizing the partition line of the specific section in the first recognition process.

2. The vehicle control system according to claim 1, wherein the surrounding recognizer is configured to execute the first recognition process when the vehicle is traveling in the straight section.

3. The vehicle control system according to claim 1, wherein the specific section includes a curve section in which the degree of curvature is equal to or greater than the threshold, and
the surrounding recognizer is configured to:
execute a second recognition process as the recognition process of the partition line when the vehicle is traveling in the curve section; and
prioritize the detection result of the electromagnetic wave sensor over the detection result of the camera in recognizing the partition line of each of the straight section and the specific section in the second recognition process.

4. The vehicle control system according to claim 3, wherein the surrounding recognizer is configured to change the recognition process of the partition line from the second recognition process to the first recognition process after the vehicle passes through the curve section and enters the straight section.

5. The vehicle control system according to claim 1, wherein the surrounding recognizer is configured to recognize the partition line based on map information, and
the driving controller is configured to:
execute first-level driving control and second-level driving control, the second-level driving control providing a higher degree of driving assistance than the first-level driving control or imposing fewer tasks on an occupant of the vehicle than the first-level driving control; and
continue the second-level driving control in a case where a first divergence for the straight section is equal to or less than a prescribed value when the vehicle is traveling in the straight section with the second-level driving control, the first divergence being a divergence between the partition line recognized based on the detection result of the camera or the electromagnetic wave sensor and the partition line recognized based on the map information.

6. The vehicle control system according to claim 1, wherein the surrounding recognizer is configured to recognize the partition line based on map information, and
the driving controller is configured to:
execute first-level driving control and second-level driving control, the second-level driving control providing a higher degree of driving assistance than the first-level driving control or imposing fewer tasks on an occupant of the vehicle than the first-level driving control; and
continue the second-level driving control in a case where a second divergence for the specific section is equal to or less than a prescribed value when the vehicle is traveling in the straight section with the second-level driving control, the second divergence being a divergence between the partition line recognized based on the detection result of the electromagnetic wave sensor and the partition line recognized based on the map information.

7. The vehicle control system according to claim 1, wherein the specific section includes a curve section in which the degree of curvature is equal to or greater than the threshold,
the surrounding recognizer is configured to recognize the partition line based on map information, and
the driving controller is configured to:
execute first-level driving control and second-level driving control, the second-level driving control providing a higher degree of driving assistance than the first-level driving control or imposing fewer tasks on an occupant of the vehicle than the first-level driving control; and
continue the second-level driving control in a case where a third divergence for the straight section and the specific section is equal to or less than a prescribed value when the vehicle is traveling in the curve section with the second-level driving control, the third divergence being a divergence between the partition line recognized based on the detection result of the electromagnetic wave sensor and the partition line recognized based on the map information.

8. The vehicle control system according to claim 1, wherein the surrounding recognizer is configured to execute a partition line correction process in a case where the vehicle is traveling in the straight section, the partition line correction process being a process that corrects the detection result of the electromagnetic wave sensor based on the detection result of the camera for the partition line of the straight section.

9. The vehicle control system according to claim 8, wherein the surrounding recognizer is configured to execute the partition line correction process in a case where the vehicle is traveling in the straight section and the specific section is present in front of the vehicle in the traveling direction thereof.

10. The vehicle control system according to claim 1, wherein the surrounding recognizer is configured to recognize the partition line of the straight section based on the detection result of the electromagnetic wave sensor in a case where the surrounding recognizer cannot recognize the partition line of the straight section based on the detection result of the camera when the vehicle is traveling in the straight section.

11. The vehicle control system according to claim 1, wherein the surrounding recognizer is configured to:
recognize the partition line based on map information; and
recognize the partition line of the specific section based on the map information in a case where the surrounding recognizer cannot recognize the partition line of the specific section based on the detection result of the electromagnetic wave sensor when the vehicle is traveling in the straight section.

12. The vehicle control system according to claim 1, wherein the specific section includes a curve section in which the degree of curvature is equal to or greater than the threshold, and
the surrounding recognizer is configured to:
recognize the partition line based on map information; and
recognize the partition line of at least one of the straight section or the specific section based on the map information in a case where the surrounding recognizer cannot recognize the partition line of the at least one of the straight section or the specific section based on the detection result of the electromagnetic wave sensor when the vehicle is traveling in the curve section.

13. The vehicle control system according to claim 1, wherein the electromagnetic wave sensor is a lidar configured to emit laser light toward the surrounding of the vehicle and receive a reflection wave of the laser light, and
the surrounding recognizer is configured to recognize the degree of curvature and the road surface gradient of the traveling path of the vehicle based on a detection result of the lidar.
